(19) United States
(12) Patent Application Publication
(10) Pub. No.: US 2026/0166552 A1
(43) Pub. Date: Jun. 18, 2026

(54) RETENTION AND TRANSFER OF LIQUIDS

(71) Applicant: HAHN-SCHICKARD-GESELLSCHAFT FÜR ANGEWANDTE FORSCHUNG E.V., Stuttgart (DE)

(72) Inventors: Truong-Tu TRUONG, Freiburg (DE); Peter JÜLG, Freiburg (DE); Yumi KAKU, Freiburg (DE); Judith SCHLANDERER, Freiburg (DE); Nils PAUST, Freiburg (DE); Tobias HUTZENLAUB, Ettenheim (DE)

(73) Assignee: HAHN-SCHICKARD-GESELLSCHAFT FÜR ANGEWANDTE FORSCHUNG E.V., Stuttgart (DE)

(21) Appl. No.: 19/532,962

(22) Filed: Feb. 6, 2026

Related U.S. Application Data
(63) Continuation of application No. PCT/EP2024/072046, filed on Aug. 2, 2024.

(30) Foreign Application Priority Data
Aug. 7, 2023 (DE) 102023207560.1

(51) Int. Cl. B01L 3/00

(52) U.S. Cl. CPC B01L 3/561; B01L 3/50273; B01L 3/567; B01L 2200/16; B01L 2400/0409; B01L 2400/0487

(57) ABSTRACT

A fluidics module is rotated about a rotation center to drive parts of a first liquid from a first liquid receiving region into a siphon channel and connecting channel, without the first liquid passing into a downstream fluidics structure via an apex of the siphon channel and without it passing from the first into a second liquid receiving region via the connecting channel. Parts of a second liquid are driven from a second liquid receiving region into the connecting channel to enclose a gas volume between the first and second liquids in the connecting channel and to hold the second liquid in the second liquid receiving region and the connecting channel. By introducing additional liquid into the first liquid receiving region, the first liquid can be emptied into a downstream fluidics structure, thereby reducing the counter-pressure in the gas volume and transferring the second liquid into the downstream fluidics structure.

### CROSS-REFERENCE TO RELATED APPLICATIONS

This application is a continuation of copending International Application No. PCT/EP2024/072046, filed Aug. 2, 2024, which is incorporated herein by reference in its entirety, and additionally claims priority from German Application No. 10 2023 207 560.1, filed Aug. 7, 2023, which is also incorporated herein by reference in its entirety.

### TECHNICAL FIELD

The present invention relates to methods, fluidics modules and fluid handling devices for holding and transferring liquids, and in particular for sequentially holding and switching liquids in centrifugal microfluidic systems.

### BACKGROUND OF THE INVENTION

New fields of application of microfluidics, for example liquid biopsies or process monitoring, require larger sample volumes than previously, wherein the volume of the required reagents generally also scales with the sample volume. Thus, microfluidic platforms experience throughput or capacity limits. For example, a maximum of a few 100 μl of a sample can be processed on centrifugal microfluidic platforms, which are known, for example, under the name “LabDisk”. In more complex analysis chains, there are less than 100 μl of sample. However, in liquid biopsy, samples of 1 ml or more are desirable. The invention described herein is in this context.

For example, a combination of robotics for dispensing liquid while performing an analysis or a sample preparation and a centrifugal microfluidic chip on which a process chain is performed can allow the processing of higher sample volumes. Examples of the present invention relate to methods, fluidics modules and systems, which can be based on robotics and a microfluidic platform, in which a combination of switching liquid, which is, for example, introduced into the microfluidic platform via robotics, and a microfluidic structure in the microfluidic platform is used to switch liquid on at a defined point in time.

Different approaches for switching liquids are known from the conventional technology.

Thus, it is known to use negative pressure by transferring a switching liquid for pumping a liquid radially inwardly. In this regard, Salar Soroori et al., “Design and implementation of fluidic micro-pulleys for flow control on centrifugal microfluidic platforms”, Microfluid Nanofluid (2014), Springer-Verlag Berlin Heidelberg 2013, pages 1117 to 1129, use a switching liquid which is forced radially outwardly with an increase in centrifugal forces, which is effected by faster rotation. A target liquid is drawn radially inwardly via a siphon channel into a target chamber by a negative pressure forming in the closed fluidic system. Switching is triggered here by an increase in the rotation frequency.

Additionally, it is known to use negative pressure by transferring a switching liquid for siphon switching. Thus, Robert Gorkin et al., “Suction-enhanced siphon valves for centrifugal microfluidic platforms”, Microfluid Nanofluid (2012), Springer-Verlag 2011, pages 345 to 354, use a negative pressure which is generated by a transfer liquid flowing past a T junction in order to switch a siphon.

Moreover, it is known to use a liquid addition for closing a vent in order to allow switching of a siphon by means of a negative pressure. In this regard, Peter Julg et al., “Automated serial dilutions for high-dynamic-range assays enabled by fill-level-coupled valving in centrifugal microfluidics”, Lab Chip, 2019, 19, pages 2205 to 2209, describe a microfluidic structure which allows switching/pumping into a further chamber depending on the fill level in a chamber. Transfer is made possible by a channel, which is referred to as a fill-level-coupled siphon, being partially filled with liquid at a certain point in time and thus no longer being accessible to air. As a result, the liquid is pumped on via a further channel, which is referred to as a transfer siphon, by generating a negative pressure by means of cooling an air volume, with which the liquid is drawn via the siphon.

U.S. Pat. No. 9,625,916 B2 describes a device and a method in centrifugal microfluidics, in which two liquid-filled chambers are separated by a siphon with an air inclusion. Here, one of the chambers can be emptied into a connected collecting structure at a low rotational frequency. The second chamber empties only at a higher frequency.

The object underlying the present invention is to provide a method, a fluidics module and a fluid handling device, which make it possible to switch liquids on at a defined point in time.

### SUMMARY

According to an embodiment, a method for holding and transferring liquid using a fluidics module which has a first liquid receiving region, a second liquid receiving region, a downstream fluidics structure, a siphon channel with an apex and a connecting channel, wherein a portion of the first liquid receiving region which is radially outward with respect to a center of rotation is connected to the downstream fluidics structure via the siphon channel, and the radially outward portion of the first liquid receiving region is fluidically connected to an outlet of the second liquid receiving region via the connecting channel, wherein the first liquid receiving region and the second liquid receiving region are vented, wherein the connecting channel has a first end which is fluidically connected to the first liquid receiving region, and a second end which opens into a radially outward portion of the second liquid receiving region, wherein the first end of the connecting channel is radially further outward than the second end of the connecting channel, wherein an outlet end of the siphon channel is arranged radially further outward than a radially outward end of the first liquid receiving region and than a radially outward end of the second liquid receiving region, may have the steps of: a) rotating the fluidics module about the center of rotation in order to drive parts of a first liquid introduced into the first liquid receiving region from the first liquid receiving region into the siphon channel and the connecting channel in order to effect liquid menisci of the first liquid in the first liquid receiving region, the siphon channel and the connecting channel without the first liquid passing into the downstream fluidics structure via an apex of the siphon channel and without the first liquid passing from the first liquid receiving region into the second liquid receiving region via the connecting channel, b) introducing a second liquid into the second liquid receiving region and rotating the fluidics module in order to drive parts of the second liquid from the second liquid receiving region into the connecting channel in order to thereby enclose a gas volume between the first liquid and the second liquid in the connecting channel and to generate a counter-pressure in the gas volume by which the second liquid is held in the second liquid receiving region and the connecting channel, and c) introducing additional liquid into the first liquid receiving region in order to move the liquid meniscus of the first liquid over the apex of the siphon channel in order to thereby empty the first liquid from the first liquid receiving region into the downstream fluidics structure via the siphon channel, thereby reducing the counter-pressure in the gas volume and transferring the second liquid from the second liquid receiving region into the downstream fluidics structure via the connecting channel and the siphon channel.

Another embodiment may have a fluidics module for performing the method according to the invention as mentioned above, which has the vented first liquid receiving region, the vented second liquid receiving region, the siphon channel and the connecting channel.

Another embodiment may have a fluidics module for performing the method according to the invention, which has the vented first liquid receiving region, the vented second liquid receiving region, the siphon channel, the connecting channel, the further liquid receiving region, the further downstream fluidics structure, the further siphon channel and the further connecting channel, wherein the further liquid receiving region is vented, the further connecting channel has a first end which is fluidically connected to the further liquid receiving region, and a second end which opens into a radially outward portion of the second liquid receiving region, wherein the first end of the further connecting channel is radially further outward than the second end of the further connecting channel, an outlet end of the further siphon channel is arranged radially further outward than a radially outward end of the further liquid receiving region and than a radially outward end of the second liquid receiving region.

According to another embodiment, a fluid handling device may have: a fluidics module according to the invention as mentioned above; and a drive device configured to rotate the fluidics module for performing a method according to the invention as mentioned above.

Examples of the invention provide a method for holding and transferring liquid using a fluidics module which comprises a first liquid receiving region, a second liquid receiving region, a downstream fluidics structure, a siphon channel with an apex and a connecting channel, wherein a portion of the first liquid receiving region which is radially outward with respect to a center of rotation is connected to the downstream fluidics structure via the siphon channel, and the radially outward portion of the first liquid receiving region is fluidically connected to an outlet of the second liquid receiving region via the connecting channel, wherein the method comprises:
a) rotating the fluidics module about the center of rotation in order to drive parts of a first liquid introduced into the first liquid receiving region from the first liquid receiving region into the siphon channel and the connecting channel in order to effect liquid menisci of the first liquid in the first liquid receiving region, the siphon channel and the connecting channel without the first liquid passing into the downstream fluidics structure via an apex of the siphon channel and without the first liquid passing from the first liquid receiving region into the second liquid receiving region via the connecting channel,
b) introducing a second liquid into the second liquid receiving region and rotating the fluidics module in order to drive parts of the second liquid from the second liquid receiving region into the connecting channel in order to thereby enclose a gas volume between the first liquid and the second liquid in the connecting channel and to generate a counter-pressure in the gas volume by which the second liquid is held in the second liquid receiving region and the connecting channel, and
c) introducing additional liquid into the first liquid receiving region in order to move the liquid meniscus of the first liquid over the apex of the siphon channel in order to thereby empty the first liquid from the first liquid receiving region into the downstream fluidics structure via the siphon channel, thereby reducing the counter-pressure in the gas volume 10 and transferring the second liquid from the second liquid receiving region into the downstream fluidics structure via the connecting channel and the siphon channel.

The first liquid receiving region, the siphon channel and the connecting channel thus constitute a switching structure which is partially filled with the first liquid, which constitutes a switching liquid, whereupon a second liquid, which constitutes an incubation liquid, is introduced into the second liquid receiving region, which constitutes an incubation structure. In order to hold the second liquid in the second liquid receiving region, the hydrostatic pressure of the second liquid in the second liquid receiving region induced by rotating, i.e. the rotation, is compensated by a hydrostatic counter-pressure of the first liquid with which the switching structure is partially filled. The counter-pressure results here from a filling height difference between the two channels connected to the first liquid receiving region, the siphon channel and the connecting channel, which occurs when adding the second liquid into the second liquid receiving region. Enclosed air is located between the second liquid and the first liquid in the connecting channel which connects the second liquid receiving region to the first liquid receiving region. Switching the second liquid from the second liquid receiving region takes place by adding additional switching liquid into the first liquid receiving region, so that the apex of the siphon is exceeded and the switching liquid is transferred completely into the downstream fluidics structure. Thus, the hydrostatic counter-pressure is eliminated and the path is free for transferring the second liquid through the siphon channel into the downstream fluidics structure.

Examples of the present invention thus provide a novel possibility for first holding liquid in a centrifugal microfluidic system and then transferring or switching it into a downstream fluidics structure. Thus, examples of the invention also make it possible to hold and switch larger liquid volumes by means of a corresponding design.

In examples, the first liquid can be introduced into the first liquid receiving region and/or the additional liquid can be introduced into the first liquid receiving region and/or the second liquid can be introduced into the second liquid receiving region manually or using a transfer module. By using a transfer module, for example as part of robotics, a substantial automation of the method can be effected. In contrast, a manual addition can reduce the complexity of the hardware used.

In examples, the fluidics module comprises a further liquid receiving region, a further downstream fluidics structure, a further siphon channel and a further connecting channel, wherein a portion of the further liquid receiving region which is radially outward with respect to a center of rotation is connected to the further downstream fluidics structure via the further siphon channel, and the radially outward portion of the further liquid receiving region is fluidically connected to the first outlet or a further outlet of the second liquid receiving region via the further connecting channel. In such examples, the method may comprise:
after or during a), rotating the fluidics module about the center of rotation in order to drive parts of a third liquid introduced into the further liquid receiving region from the further liquid receiving region into the further siphon channel and the further connecting channel in order to effect liquid menisci of the third liquid in the further liquid receiving region, the further siphon channel and the further connecting channel without the third liquid passing into the further downstream fluidics structure via an apex of the further siphon channel and without the third liquid passing from the further liquid receiving region into the second liquid receiving region via the further connecting channel,
after c), introducing a fourth liquid into the first liquid receiving region and rotating the fluidics module in order to drive parts of the fourth liquid from the first liquid receiving region into the siphon channel and the connecting channel in order to effect liquid menisci of the fourth liquid in the first liquid receiving region, the siphon channel and the connecting channel without the fourth liquid passing into the downstream fluidics structure via an apex of the siphon channel and without the fourth liquid passing from the first liquid receiving region into the second liquid receiving region via the connecting channel,
introducing a fifth liquid into the second liquid receiving region and rotating the fluidics module in order to drive parts of the fifth liquid from the second liquid receiving region into the connecting channel and the further connecting channel in order to thereby enclose a gas volume between the third liquid and the fifth liquid in the further connecting channel and between the fourth liquid and the fifth liquid in the connecting channel and to generate a further counter-pressure by which the fifth liquid is held in the second liquid receiving region and the further connecting channel, and
introducing additional liquid into the further liquid receiving region in order to move the liquid meniscus of the third liquid over the apex of the further siphon channel in order to thereby empty the third liquid from the further liquid receiving region into the further downstream fluidics structure via the further siphon channel, thereby reducing the further counter-pressure and transferring the fifth liquid from the second liquid receiving region into the further downstream fluidics structure via the further connecting channel and the further siphon channel.

In examples, the method is thus repeatable, i.e., in addition to transferring a first switching liquid and a first incubation liquid, at least one further switching liquid (third liquid) and one further incubation liquid (fifth liquid) can be added and further holding and switching steps can be performed.

In examples, transferring the second liquid and/or fifth liquid into the downstream fluidics structure can cause the second and/or fifth liquid to be brought into contact with a reagent. Examples thus make it possible in a suitable manner to hold the second and/or fifth liquid in a suitable fluidics structure before transferring the second and/or fifth liquid into a downstream fluidics structure comprising a reagent.

Examples of the invention provide a fluidics module for performing methods as described herein, which comprises the first liquid receiving region, the second liquid receiving region, the siphon channel and the connecting channel, wherein
the first liquid receiving region is vented,
the second liquid receiving region is vented,
the connecting channel comprises a first end which is fluidically connected to the first liquid receiving region, and a second end which opens into a radially outward portion of the second liquid receiving region, wherein the first end of the connecting channel is radially further outward than the second end of the connecting channel, and
an outlet end of the siphon channel is arranged radially further outward than a radially outward end of the first liquid receiving region and than a radially outward end of the second liquid receiving region.

Such a fluidics module is configured to perform the methods according to the invention described herein by the siphon channel and the connecting channel each comprising radially rising portions in order to make it possible to hold the first liquid in the first liquid receiving region, the siphon channel and the connecting channel and in order to make it possible for the hydrostatic pressure of the second liquid induced by the rotation to be compensated by the hydrostatic counter-pressure of the switching liquid in order to hold both liquids before switching the liquids into the downstream fluidics structure.

Examples of the present invention provide a fluidics module for performing a method as described above, in which a third and a fifth liquid are further held and transferred, which comprises the first liquid receiving region, the second liquid receiving region, the siphon channel, the connecting channel, the further liquid receiving region, the further downstream fluidics structure, the further siphon channel and the further connecting channel, wherein
the first liquid receiving region is vented,
the second liquid receiving region is vented,
the further liquid receiving region is vented,
the connecting channel comprises a first end which is fluidically connected to the first liquid receiving region, and a second end which opens into a radially outward portion of the second liquid receiving region, wherein the first end of the connecting channel is radially further outward than the second end of the connecting channel,
an outlet end of the siphon channel is arranged radially further outward than a radially outward end of the first liquid receiving region and than a radially outward end of the second liquid receiving region,
the further connecting channel comprises a first end which is fluidically connected to the further liquid receiving region, and a second end which opens into a radially outward portion of the second liquid receiving region, wherein the first end of the further connecting channel is radially further outward than the second end of the further connecting channel,
an outlet end of the further siphon channel is arranged radially further outward than a radially outward end of the further liquid receiving region and than a radially outward end of the second liquid receiving region.

In such examples, the connecting channel, the further connecting channel, the siphon channel and the further siphon channel each comprise radially rising portions which make the described functionality possible. Such examples thus make it possible to hold and transfer further liquids. The first and the third liquid thus constitute switching liquids and the first and the further liquid receiving region constitute switching liquid receiving regions. In examples, still further switching liquid regions can be provided which make it possible in a corresponding manner to hold and switch at least one further incubation liquid from the second liquid holding region.

In examples, in the azimuthal direction, the first liquid receiving region is arranged on one side of the second liquid receiving region and the further liquid receiving region is arranged on an opposite side of the second liquid receiving region.

In examples, the connecting channel comprises a channel portion which extends radially inwardly and is arranged in the azimuthal direction on one side of the first liquid receiving region, and the siphon channel comprises a channel portion which extends radially inwardly and is arranged in the azimuthal direction on an opposite side of the first liquid receiving region. Such examples make it possible to arrange them in a space-saving manner in the fluidics module.

In examples, the first liquid receiving region is a fluid chamber, wherein the connecting channel and the siphon channel open into the fluid chamber on opposite azimuthal sides.

Examples of the invention provide a fluid handling device comprising a fluidics module as described herein, and a drive device which is configured to rotate the fluidics module for performing a method according to the invention. In examples, the fluid handling device additionally comprises at least one transfer module configured to introduce the first liquid into the first liquid receiving region and/or to introduce the additional liquid into the first liquid receiving region and/or to introduce the second liquid into the second liquid receiving region. Examples thus make it possible to perform the methods as described herein in an at least partially automated manner.

### BRIEF DESCRIPTION OF THE DRAWINGS

Examples of the present invention are explained in more detail below referring to the appended drawings, in which:

FIG. 1 shows a schematic top view of fluidics structures of an example of a fluidics module according to the invention for holding and switching a first and a second liquid;

FIGS. 2A to 2D show schematic illustrations of the fluidics module of FIG. 1 for explaining an embodiment of a method according to the invention;

FIGS. 3A to 3D show schematic top views of fluidics structures of a further example of a fluidics module according to the invention for explaining a further embodiment of a method according to the invention for holding and switching a first, second, third and fifth liquid; and

FIGS. 4A and 4B show schematic illustrations of examples of fluid handling devices according to the invention.

### DETAILED DESCRIPTION OF THE INVENTION

Examples of the present disclosure are described below in detail and using the appended drawings. It is to be noted that same elements or elements having the same functionality are provided with the same or similar reference numerals, and a repeated description of elements provided with the same or similar reference numerals is typically omitted. In particular, same or similar elements may each be provided with reference numerals having a same number with a different or no lower case letter. Descriptions of elements having the same or similar reference numerals may be mutually interchangeable. In the following description, many details are described to provide a more thorough explanation of examples of the disclosure. However, it will be apparent to those skilled in the art that other examples may be implemented without these specific details. Features of the different examples described may be combined with one another, unless features of a corresponding combination are mutually exclusive or such a combination is explicitly excluded.

Before examples of the present disclosure are explained in more detail, definitions of some terms used herein are given.

### Fluidics Module

A fluidics module is to be understood here to be a module which comprises fluidics structures which are configured to make it possible to handle liquids as described herein. The fluidics structures in this case comprise the fluid receiving regions and channels described herein. In examples, the fluidics structures are microfluidic structures which are configured for processing liquids in the picoliter to milliliter range and have suitable dimensions in the micrometer range for handling corresponding liquid volumes. In examples, the fluidics module is a centrifugal microfluidic chip.

### Centrifugal Microfluidic Chip

Device for performing fluidic and/or biochemical processes while rotating about a center of rotation. The centrifugal microfluidic chip contains microfluidic structures such as channels and chambers in which liquids are moved. This liquid movement is triggered, driven and controlled by rotating the chip by a rotation unit. Fluidics modules as described herein can be formed by centrifugal microfluidic chips.

### Transfer Module

Device (e.g. dispenser, pipette, gripper, etc.) for dispensing liquids or other substances and substance mixtures in a precise and time-controlled manner. It transfers samples, reagents and switching liquids into the centrifugal microfluidic chip and optionally products out of the centrifugal microfluidic chip. A transfer module may, for example, be implemented using robotics.

### Liquid

As will be apparent to those skilled in the art, the term liquid as used herein also includes, in particular, liquids containing solid constituents, such as suspensions, biological samples and reagents.

### Sample

In this context, a substance mixture is referred to as a sample (e.g. blood sample, water sample, process sample, skin sample, insects, etc.), which is analyzed completely or partially within a fluidics module (centrifugal microfluidic chip) and associated driving device (rotation unit) or prepared therein for subsequent analysis (e.g. DNA extraction).

### Reagents

In this context, all substances and substance mixtures which are used for analyzing or preparing the sample within the centrifugal microfluidic chip and associated driving device (rotation unit) are referred to as reagents (e.g. washing buffers, acids, dilutions, nanoparticles, etc.).

### Switching Liquid

The function of switching liquids is to implement a switching process. Switching liquids are used here to switch other liquids. In addition, switching liquids can also be additionally used for interaction, for example for dilution or for mixing with the sample, for example in a downstream fluidics structure.

### Incubation Liquid

Incubation liquid is understood herein to mean a liquid which is the subject of processing and/or examination and for this purpose can interact with other substances or is incubated with other substances.

### Siphon Channel

Microfluidic channel located in a fluidics module (centrifugal microfluidic chip) or part of a microfluidic channel, in which channel portions before and after an intermediate portion of the channel have a larger distance from the center of rotation than an intermediate portion of the channel (inverse siphon). An apex of the siphon is to be understood to be the region of the siphon channel with minimum distance from the center of rotation.

### Hydrostatic Pressure

The hydrostatic pressure p_{hydrostatic} on a liquid column in a channel in the centrifugal gravitational field can be calculated using the following formula:

$$Δ {p}_{hydrostatic} = \frac{ρ}{2} * {ω}^{2} * ( {r}_{a}^{2} - {r}_{i}^{2} )$$

Here, ρ stands for the density of the liquid, ω for the angular speed at which the channel rotates about the center of rotation, rₐ for the outer radius of the liquid column and rᵢ for the inner radius of the liquid column.

### Fluid Channel/Fluid Chamber

If a fluid channel is referred to herein, this means a structure whose length dimension from a fluid inlet to a fluid outlet is greater, for example more than 5 times or more than 10 times greater, than the dimension or dimensions which defines or define the flow cross section. A fluid channel thus has a flow resistance for flowing through it from the fluid inlet to the fluid outlet. By contrast, a fluid chamber is a chamber which has such dimensions that, when flowing through the chamber, a flow resistance which is negligible in comparison with connected channels occurs, which flow resistance can be, for example, 1/100 or 1/1000 of the flow resistance of the channel structure connected to the chamber with the smallest flow resistance.

### Radial

If the term radial is used herein, this always means radially with respect to the center of rotation about which the fluidics module or the rotation body is rotatable. In the centrifugal field, a radial direction is thus radially decreasing from the center of rotation and a radial direction towards the center of rotation is radially increasing. A fluid channel the start of which is closer to the center of rotation than its end is thus radially decreasing, while a fluid channel the start of which is further away from the center of rotation than its end is radially increasing. A channel which comprises a radially increasing portion thus comprises directional components which increase radially or extend radially inwards. It is clear that such a channel does not have to extend exactly along a radial line, but can extend at an angle to the radial line or in a curved manner. Radially further outward thus means further away from the center of rotation and radially further inward means closer to the center of rotation.

If nothing else is given herein, room temperature (20° C.) is always to be assumed with respect to temperature-dependent variables.

Examples of the present invention are directed to methods and devices for holding liquids and for specifically switching liquids at a desired point in time, in particular in a centrifugal microfluidic chip. Corresponding devices can be monolithically integrated into the centrifugal microfluidic chip or manufactured easily. In examples, the structured microfluidic chip comprises no additional components, for example wax valves, which have to be melted. In examples, the method according to the invention can be largely independent of time, temperature and frequency protocols and can be adapted to a wide range of volumes.

Holding the incubation liquid (second and fifth liquids in the claims), which can be samples and/or reagents, while rotating in a structure, which is also referred to below as incubation chamber, can be carried out by a compensating counter-pressure from a structure partially filled with switching liquid (first and third liquids in the claims), connected via a channel, which is also referred to below as switching structure. The switching structure can consist of a switching chamber and two connected channels, the siphon channel and the connecting channel. Here, in the method, the switching structure can at first be filled partially with switching liquid. Subsequently, the incubation structure is filled with incubation liquid. In order to hold the incubation liquid in the incubation structure, the hydrostatic pressure of the incubation liquid in the incubation structure induced by the rotation is compensated by a hydrostatic counter-pressure of the switching liquid. The counter-pressure here results from the filling height difference between the two channels connected to the switching chamber (siphon channel and connecting channel), which occurs when adding the incubation liquid into the incubation structure. Enclosed air is located between the incubation liquid and the switching liquid in the connecting channel which connects the incubation structure to the switching structure.

Switching the incubation liquid from the incubation structure takes place by adding additional switching liquid into the switching structure already partially filled with switching liquid. The switching structure is connected to subsequent microfluidics via the siphon channel, which contains an inverse siphon. Additionally adding switching liquid causes the apex of the siphon to be exceeded and the switching liquid to be switched completely into the subsequent structure (downstream fluidics structure). Thus, the hydrostatic counter-pressure is eliminated and the path is free for transferring the incubation liquid so that it can in turn be switched into the subsequent microfluidic structure. The switching liquid and/or the incubation liquid can be presented or added either manually, for example by means of a pipette, or by means of a transfer module. The method is repeatable, i.e., after transferring a first switching and incubation liquid, at least one second switching and incubation liquid could be added and further holding and switching steps could be performed.

In contrast to the methods described above for the known technology by Soroori and Gorkin, according to the invention switching is triggered by adding liquid, which makes it largely independent of frequency. In the above-mentioned known technology by Jülg, a vent is closed by adding liquid, thereby making it possible to draw liquid via the siphon by means of negative pressure. According to the invention, adding switching liquid causes the siphon to be exceeded by the switching liquid, the switching liquid to be switched into the subsequent structure, and thus the path is free for transferring the incubation liquid (sample/reagents) so that it can be switched on into the subsequent structure. In contrast to the known technology described in U.S. Pat. No. 9,625,916 B2, according to the invention switching is triggered by adding liquid, so that it is largely independent of frequency. Also, in examples of the invention no siphon is required between the incubation chamber and the switching chamber, but a siphon channel connects both the switching chamber and the incubation chamber to the subsequent microfluidics.

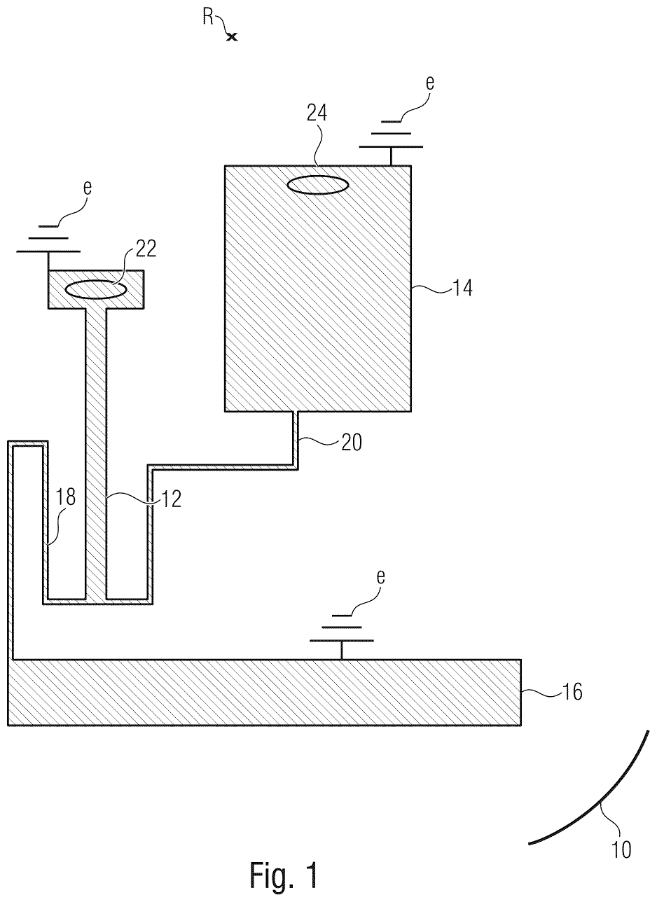

FIG. 1 shows an example of a fluidics module 10 according to the invention, which comprises fluidics structures for performing embodiments of methods described herein. The fluidics structures comprise a first liquid receiving region 12, a second liquid receiving region 14, downstream fluidics structures 16, a siphon channel 18 and a connecting channel 20. In the embodiment shown, the first liquid receiving region 12 is formed by a switching chamber and the second liquid receiving region 14 is formed by an incubation chamber. In the following, reference is thus made to the switching chamber 12 and the incubation chamber 14. However, it is not necessary to explain separately that the liquid receiving regions may also be formed by several chambers or chamber-like fluidics structures which are configured to receive liquid in order to perform the methods described herein. The downstream fluidics structure 16 may also be formed by a fluid chamber in which, for example, reagents are arranged upstream. However, it is not necessary to explain further that the downstream fluidics structure 16 may be formed by any subsequent microfluidics into which the liquids are transferred from the siphon channel 18, wherein the latter is arranged downstream since it is located downstream with respect to the siphon channel 18.

The switching chamber 12, the incubation chamber 14 and the downstream fluidics structure 16 are each vented, as indicated by vents e in FIG. 1, such that, when liquids are introduced into or emptied from the latter when performing the methods, no positive pressure or negative pressure influencing the methods is generated in the switching chamber 12, the incubation chamber 14 and the downstream fluidics structure 16.

A radially outward portion of the switching chamber 12 is connected to the downstream fluidics structure 16 via the siphon channel 18. The radially outward portion of the switching chamber 12 is connected to an outlet of the incubation chamber 14 via the connecting channel 20. In the example shown in FIG. 1, the siphon channel 18 opens into the radially outward end of the switching chamber 12, which makes complete emptying of the switching chamber 12 via the siphon channel 18 possible. In other examples, the siphon channel 18 and/or the connecting channel 20 could open into the switching chamber 12 at a distance from the radially outward end. The connecting channel 20 comprises a first end which is fluidically connected to the switching chamber 12, and a second end which opens into a radially outward portion, for example a radially outward end, of the incubation chamber 14. The first end of the connecting channel 20 is arranged radially further outward than the second end of the connecting channel 20. The connecting channel thus increases radially from the switching chamber 12 to the incubation chamber 14 or comprises at least one radially increasing portion. The siphon channel comprises a radially increasing portion up to a radially inner apex of the siphon thereof. An outlet end of the siphon channel 18 which opens into the downstream fluidics structure 16 is arranged radially further outward than a radially outward end of the switching chamber 12 and than a radially outward end of the incubation chamber 14. It is thus possible to empty the switching chamber 12 and the incubation chamber 14 via the siphon channel 18 completely, or at least up to the respective radial position at which the siphon channel 18 or the connecting channel 20 opens into the same.

In the example shown, the siphon channel 18 and the connecting channel 20 open into the switching chamber 12 on azimuthally opposite sides. The switching chamber 12 and a channel which is formed by the siphon channel 18 and the connecting channel 20 thus form a T junction. In alternative embodiments, the connecting channel 20 does not open into the switching chamber 12, but opens into the siphon channel 18, i.e. in a region thereof which lies between the inverse siphon thereof and the opening of the siphon channel into the switching chamber 12.

As shown in FIG. 1, the switching chamber 12 and the incubation chamber 14 can have respective inlets 22 and 24 via which liquids can be introduced into the switching chamber 12 and the incubation chamber 14.

In examples, the fluidics module thus comprises an incubation chamber which is vented and provided with a possibility of introducing incubation liquid into the incubation chamber, wherein the incubation chamber is connected to a switching chamber which is radially further outward, via a connecting channel. The switching chamber is additionally connected to a siphon channel, the course of which contains an inverse siphon and connects the device according to the invention to subsequent microfluidics of any type. Switching chamber, connecting channel and siphon channel can be referred to as switching structure which is vented and provided with a possibility of introducing switching liquid into the switching structure.

As shown in FIG. 1, the connecting channel comprises a channel portion which extends radially inwardly and is arranged in the azimuthal direction on one side of the switching chamber 12, and the siphon channel 18 comprises a channel portion which extends radially inwardly and is arranged in the azimuthal direction on an opposite side of the switching chamber 12. This makes it possible to arrange the fluidics structures in the fluidics module 10 in a space-saving manner. Alternatively, the radially inwardly extending portions could also be arranged on the same side of the switching chamber 12. In examples, the connecting channel does not comprise an inverse siphon.

In the example shown in FIG. 1, the connecting channel 20 comprises a first channel portion which extends radially outwardly from the incubation chamber 14, a second channel portion which extends from the first channel portion at least partially in the azimuthal direction, and a third channel portion which extends radially outwardly from the second channel portion. In other examples, the connecting channel can have a different course, for example a straight or curved channel which connects the radially outward portion of the switching chamber 12 to the radially outward portion of the incubation chamber 14 and is correspondingly small in order to make stable air inclusion possible.

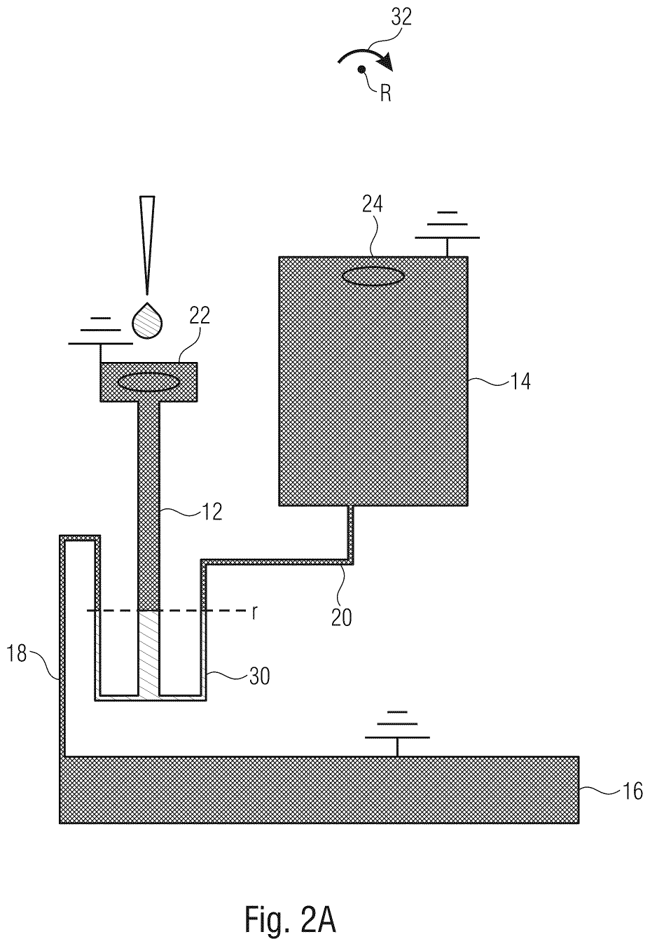

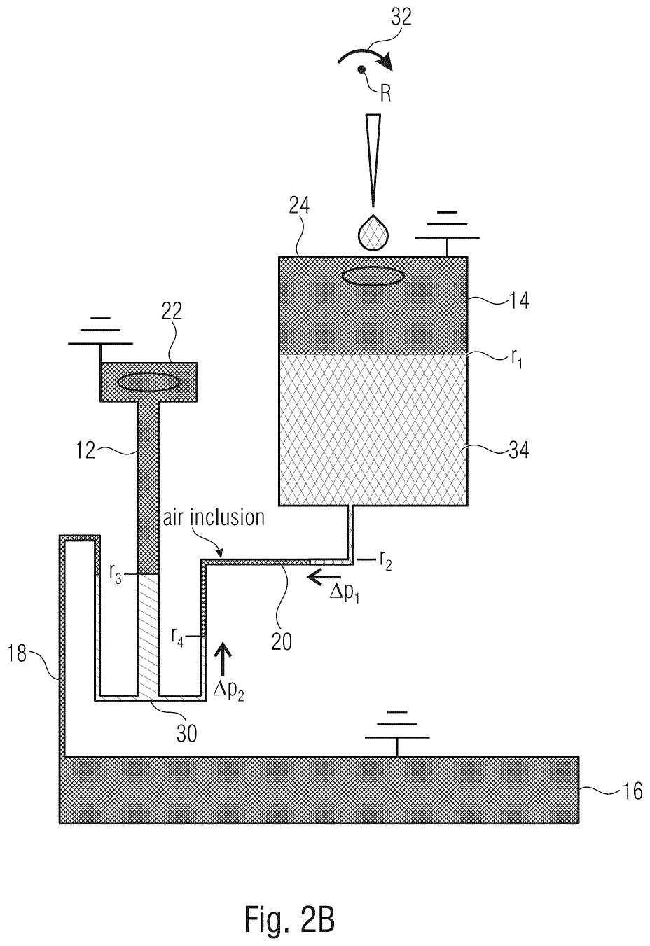

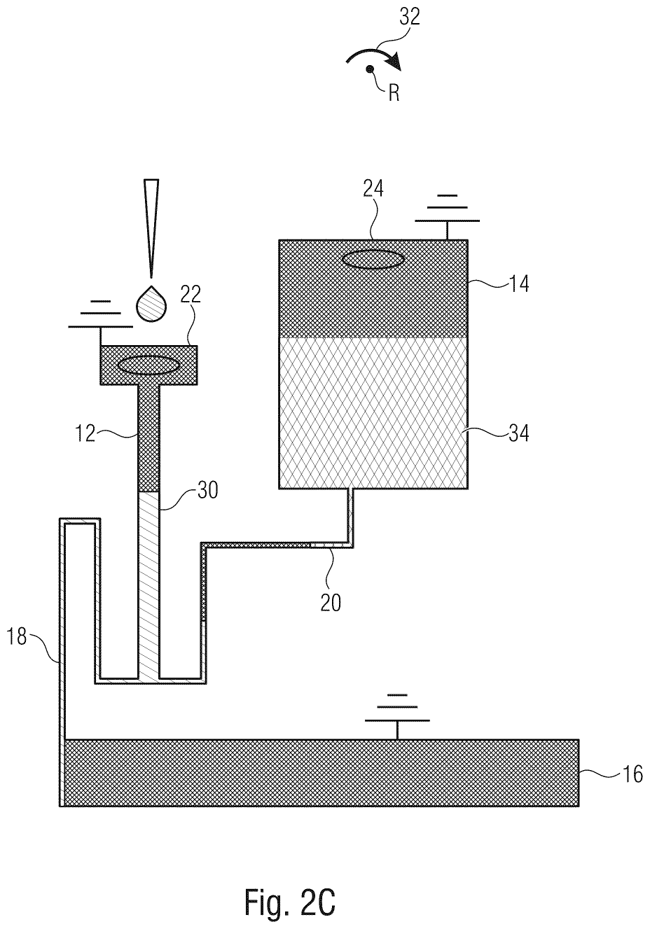

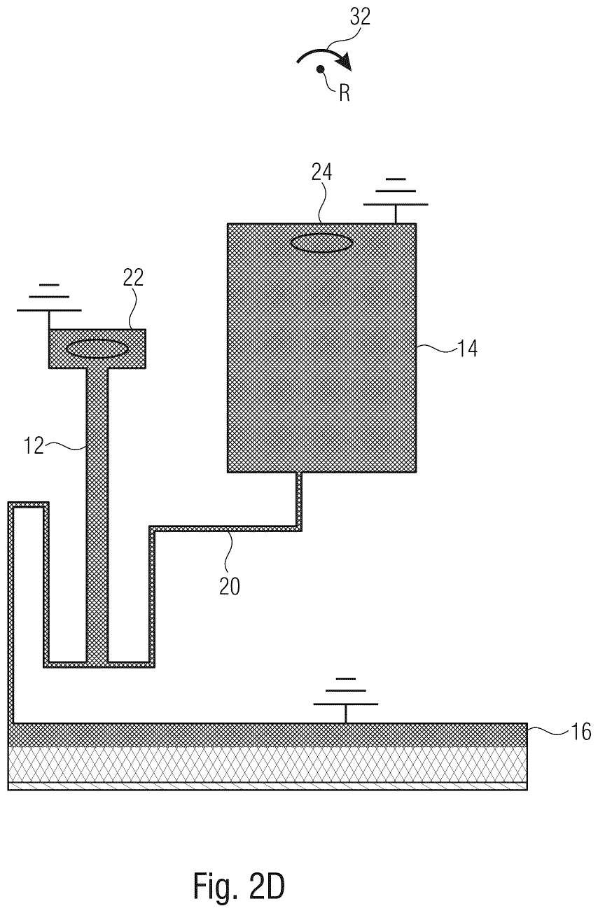

In the following, an embodiment of a method for holding and transferring liquid is described referring to the fluidics module 10 shown in FIG. 1 and referring to FIGS. 2a to 2d.

In a first step, which can be referred to as switching in, the switching structure which is formed by the switching chamber 12, the siphon channel 18 and the connecting channel 20 is partially filled with switching liquid 30, for example via the inlet 22, so that, under rotation, an apex of the inverse siphon located in the siphon channel 18 is not exceeded. The filling may, for example, take place manually by means of a pipette or via a transfer module. If a transfer module is used, this may also take place under rotation. As shown by an arrow 32 in FIG. 2a, the fluidics module is rotated about the center of rotation R in order to drive parts of the switching liquid introduced into the switching chamber 12 from the switching chamber 12 into the siphon channel 18 and the connecting channel 20 in order to effect liquid menisci of the switching liquid in the switching chamber 12, the siphon channel 18 and the connecting channel 20 without the switching liquid 30 passing into the downstream fluidics structure 16 via the apex of the siphon channel 18 and without the switching liquid passing from the switching chamber 12 into the incubation chamber 14 via the connecting channel 20. The switching liquid may be introduced into the switching structure before the rotation of the fluidics module is started, while the rotation of the fluidics module is started, or after the rotation of the fluidics module has been started. Due to the rotation, the switching liquid is located radially outwards in the switching structure. The liquid menisci in the siphon channel 18, the switching chamber 12 and the connecting channel 20 are located at a radial height r, as shown in FIG. 2a.

In a second step, which can be referred to as holding, incubation liquid 34 is introduced into the incubation chamber 14, for example via the inlet 24. This may, for example, take place using a transfer module while rotating. While rotating, the incubation liquid 34 is located radially outwards in the incubation chamber 14 and a part of the incubation liquid 34 penetrates into the connecting channel 20, which results in an air inclusion between the incubation liquid 34 and the switching liquid 30 in the connecting channel 20. Due to the penetration, the air in the connecting channel 20 is compressed and the pressure results in the liquid menisci in the siphon channel 18 and the switching chamber 12 to shift radially inwards, see r₃ in FIG. 2b, and the liquid menisci in the connecting channel to shift radially outwards, see r₄ in FIG. 2b. The liquid meniscus of the incubation liquid 34 in the connecting channel 20 is located at r₂. Due to the different heights of the liquid menisci in the switching structure, a hydrostatic pressure Δp₂ forms. This pressure Δp₂ constitutes a counter-pressure to the hydrostatic pressure Δp₁ of the incubation liquid 34 in the incubation chamber 14 and the connecting channel 20. If the pressures are equal, an equilibrium state occurs in which the incubation liquid 34 cannot penetrate further into the connecting channel 20 and is held in the incubation chamber 14.

In other words, a second liquid, the incubation liquid 34, is introduced into a second liquid receiving region, the incubation chamber 14, and the fluidics module is rotated in order to drive parts of the incubation liquid 34 from the incubation chamber 14 into the connecting channel 20 in order to thereby enclose a gas volume between the switching liquid 30 and the incubation liquid 34 in the connecting channel 20 and to generate a counter-pressure in the gas volume by which the incubation liquid 34 is held in the incubation chamber 34 and the connecting channel 20.

In a third step, which can be referred to as switching open and emptying, additional switching liquid is introduced into the switching structure. This may, for example, take place by means of a transfer module while rotating. By adding the additional switching liquid, the liquid menisci in the switching chamber 12 and the siphon channel 18 increase in parallel, since a pressure gradient between the liquid menisci in the switching chamber 12 and the siphon channel 18 is not stable until the apex of the inverse siphon in the siphon channel 18 is exceeded. As soon as this is the case, the switching liquid 30 empties into the subsequent microfluidics 16, as shown in FIG. 2c. Since there is no longer any counter-pressure in order to hold the incubation liquid 34 in the incubation chamber 14, the same is also transferred into the subsequent microfluidics 16. The resulting state is shown in FIG. 2d. In other words, additional liquid is introduced into the switching chamber 12, which constitutes a first liquid receiving region, in order to move the liquid meniscus of the switching liquid 30 over the apex of the siphon channel 18 in order to thereby empty the first liquid 30 from the switching chamber 12 into the downstream fluidics structure 16 via the siphon channel 18, thereby reducing the counter-pressure in the gas volume and transferring the incubation liquid 34 from the incubation chamber 14 into the downstream fluidics structure 16 via the connecting channel 20 and the siphon channel 18.

In FIGS. 2a to 2d, a respective rotation is shown by an arrow 32. The rotation speed may remain the same during the method.

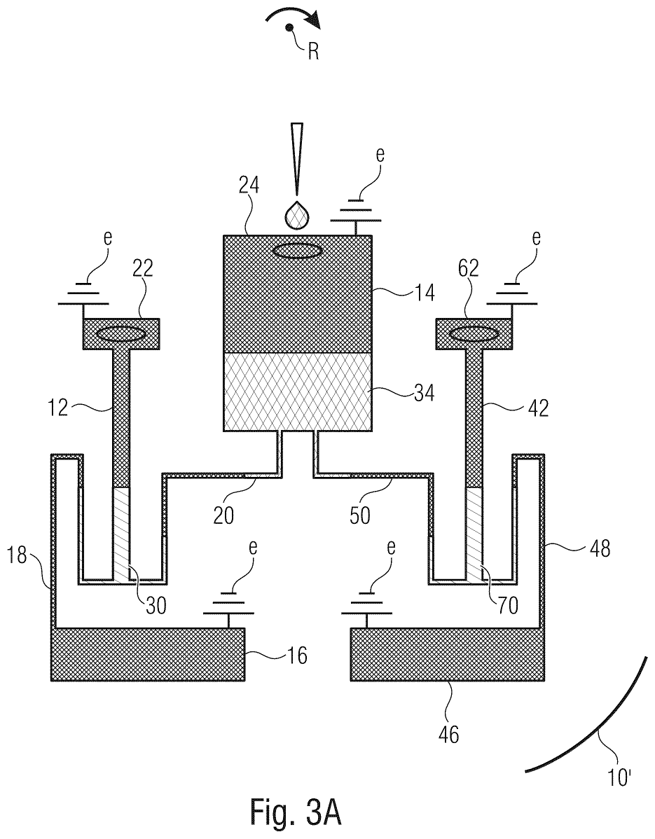

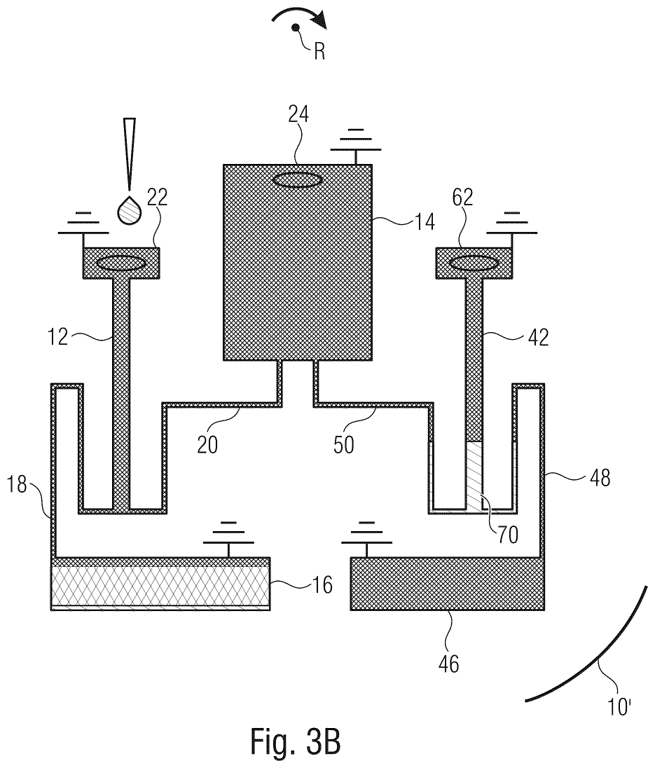

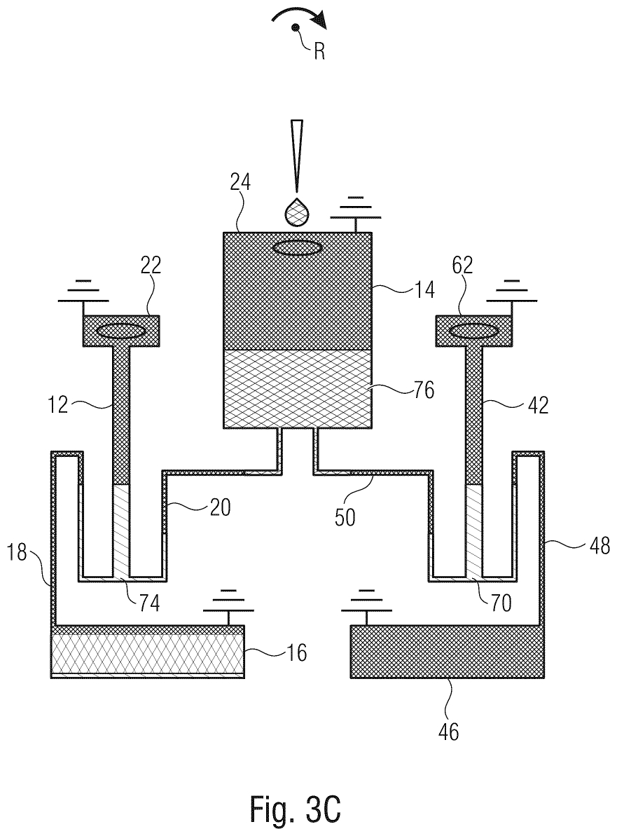

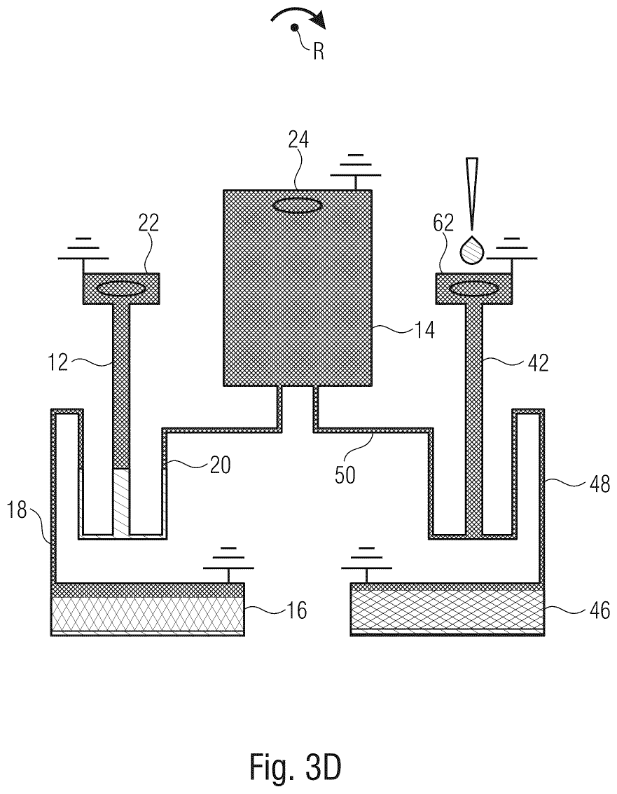

The method described referring to FIGS. 2a to 2d serves to transfer an incubation liquid 34 into a downstream fluidics structure 16 by means of a switching liquid 30. Referring to FIGS. 3a to 3d, a fluidics module and a method are described below which are suitable for transferring a first incubation liquid into a first downstream fluidics structure and a second incubation liquid into a second downstream fluidics structure by means of respective switching liquids.

At first, the fluidics structures of a corresponding fluidics module 10′ are described referring to FIG. 3a, wherein elements corresponding to those in FIG. 1 are denoted by the same reference numerals, and with regard to the description thereof, reference is made to the above explanations. The fluidics structures comprise, in addition to the switching chamber 12, the incubation chamber 14, the downstream fluidics structure 16, the siphon channel 18 and the connecting channel 20, a further liquid receiving region 42, a further downstream fluidics structure 46, a further siphon channel 48 and a further connecting channel 50. The further liquid receiving region 42 is in turn formed by a fluid chamber which constitutes a switching chamber. The switching chamber 42 comprises an inlet 62. Otherwise, the above explanations with respect to the switching chamber 12, the downstream fluidics structure 16, the siphon channel 18 and the connecting channel 20 apply correspondingly to the further switching chamber 42, the downstream fluidics structure 46, the siphon channel 48 and the connecting channel 50. This means that the further switching chamber 42 is also vented, that the further connecting channel 50 comprises a first end which is fluidically connected to the further switching chamber, and a second end which opens into a radially outward portion of the incubation chamber, wherein the first end of the further connecting channel 50 is radially further outward than the second end of the further connecting channel 50, and that an outlet end of the further siphon channel 48 is arranged radially further outward than a radially outward end of the further switching chamber and than a radially outward end of the incubation chamber. The switching chamber 12 and the further switching chamber 42 are arranged in the azimuthal direction on opposite sides of the incubation chamber 14. The second connecting channel 50 can open into a further outlet of the incubation chamber 14, as shown in FIG. 3a. In other examples, the two connecting channels can also open into a common outlet of the incubation chamber, for example via a T-connection.

The fluidics module 10′ shown in FIG. 3a thus comprises fluidics structures in which the switching structure is duplicated in order to make it possible to switch two incubation liquids into downstream fluidics structures 16, 46. The further switching chamber 42, the siphon channel 48 and the connecting channel 50 thus constitute a further switching structure.

Embodiments may thus contain several switching structures on the same incubation chamber, which are each connected to their own subsequent microfluidics. Thus, incubation liquids can be switched successively into different subsequent microfluidic structures. Thus, the sequence and direction of the incubation liquids are determined while corresponding to the actuation of the different switching structures in accordance with the method described above.

FIG. 3a shows a state after a process phase, which corresponds to the state shown in FIG. 2b. Thus, in addition to the introduction of a first switching liquid 30 into the first switching structure, a further switching liquid 70 was introduced into the further switching structure. The further switching liquid 70 may, for example, have been introduced via the inlet 62. Introducing the switching liquid 70 may take place together with introducing the switching liquid 30 or before or after. Otherwise, with respect to generating the arrangement of the further switching liquid 70 shown in FIG. 3a in the further switching structure, the above explanations with respect to the switching liquid 30 in the first switching structure apply in the same way. More specifically, before, after or during rotating the fluidics module 10′ in order to introduce the further switching liquid 70 into the further switching chamber 42, the fluidics module is rotated about the center of rotation R in order to drive parts of the further switching liquid 70 (third liquid) introduced into the further switching chamber 42 from the switching chamber 42 into the further siphon channel 48 and the further connecting channel 50 in order to effect liquid menisci of the further switching liquid 70 in the further switching chamber 42, the further siphon channel 48 and the further connecting channel 50 without the further switching liquid 70 passing into the further downstream fluidics structure 46 via an apex of the further siphon channel 48 and without the further switching liquid 70 passing from the further switching chamber 42 into the incubation chamber 14 via the further connecting channel 50.

Furthermore, in the state shown in FIG. 3a, the incubation liquid 34 was already introduced into the incubation chamber 14 while rotating in order to drive parts of the incubation liquid 34 from the incubation chamber 14 into the connecting channel 20 and the further connecting channel 50 in order to thereby enclose a gas volume between the switching liquid 30 and the incubation liquid 34 and between the further switching liquid 70 and the incubation liquid 34 and to generate a counter-pressure in the gas volume by which the incubation liquid 34 is held in the incubation chamber and the connecting channels 20 and 50. The incubation liquid 34 is introduced after the switching liquids 30 and 70 have been introduced into the switching structures.

Starting from the state shown in FIG. 3a, additional switching liquid is then at first introduced into the first switching chamber 12 so that, corresponding to the above description of FIGS. 2c and 2d, the switching liquid 30 empties from the switching chamber 12 and then the incubation liquid 34 empties from the incubation chamber 14 into the first downstream fluidics structure 16. The resulting state is shown in FIG. 3b.

Starting from this state, a further switching liquid 74 (fourth liquid) is at first introduced into the first switching chamber 12 while rotating in order to drive parts of the further switching liquid 74 from the first switching chamber 12 into the siphon channel 18 and the connecting channel 20 in order to effect liquid menisci of the fourth liquid in the switching chamber 12, the siphon channel 18 and the connecting channel 20 without the further switching liquid 74 passing into the downstream fluidics structure 16 via the apex of the siphon channel 18 and without the further switching liquid 74 passing from the switching chamber 12 into the incubation chamber 14 via the connecting channel 20. Then, a further incubation liquid 76 (fifth liquid) is introduced into the incubation chamber 14 while further rotating in order to drive parts of the further incubation liquid 76 from the incubation chamber 14 into the connecting channel 20 and the further connecting channel 50 in order to enclose a gas volume between the switching liquid 70 and the incubation liquid 76 in the further connecting channel 50 and to enclose a gas volume between the further switching liquid 74 and the further incubation liquid 76 in the connecting channel 20. As described above, a counter-pressure by which different menisci occur in the switching structures, is generated by each of these gas volumes.

Starting from the state shown in FIG. 3c, additional switching liquid is then introduced into the further switching chamber 42 in order to effect that the meniscus of the switching liquid 70 in the further switching structure exceeds the apex of the siphon channel 48 and the switching chamber 42 empties into the further downstream fluidics structure 46. The counter-pressure between the switching liquid 70 and the incubation liquid 76 is reduced by this and also the incubation liquid 76 empties into the further fluidics structure 46 via the siphon channel 48. The state shown in FIG. 3d is achieved by this.

Thus, in the method described referring to FIGS. 3a to 3d, a first incubation liquid 34 is at first switched into the downstream fluidics structure 16 and then a further incubation liquid 76 is switched into the downstream fluidics structure 46.

The different liquids are numbered here, for example in the appended claims, wherein the numbering serves only to distinguish the liquids and does not necessarily define any order. The first liquid, the third liquid and the fourth liquid thus constitute switching liquids, whereas the second liquid and the fifth liquid constitute incubation liquids. The switching liquids may each be same or different liquids. The incubation liquids may also be same or different liquids. The switching liquids and the incubation liquids may also be the same.

Examples of the present invention provide a fluid handling device comprising fluidics modules as described herein and a drive device, for example a rotation unit, configured to rotate the fluidics module for performing the methods as described herein or to achieve the functionalities described herein. The fluid handling device can additionally comprise a transfer module configured to introduce the respective liquids into the respective fluid receiving regions, for example the first liquid into the first liquid receiving region, the additional liquid into the first liquid receiving region, the second liquid into the second liquid receiving region, the third liquid into the further liquid receiving region, the fourth liquid into the first liquid receiving region and/or the fifth liquid into the second liquid receiving region.

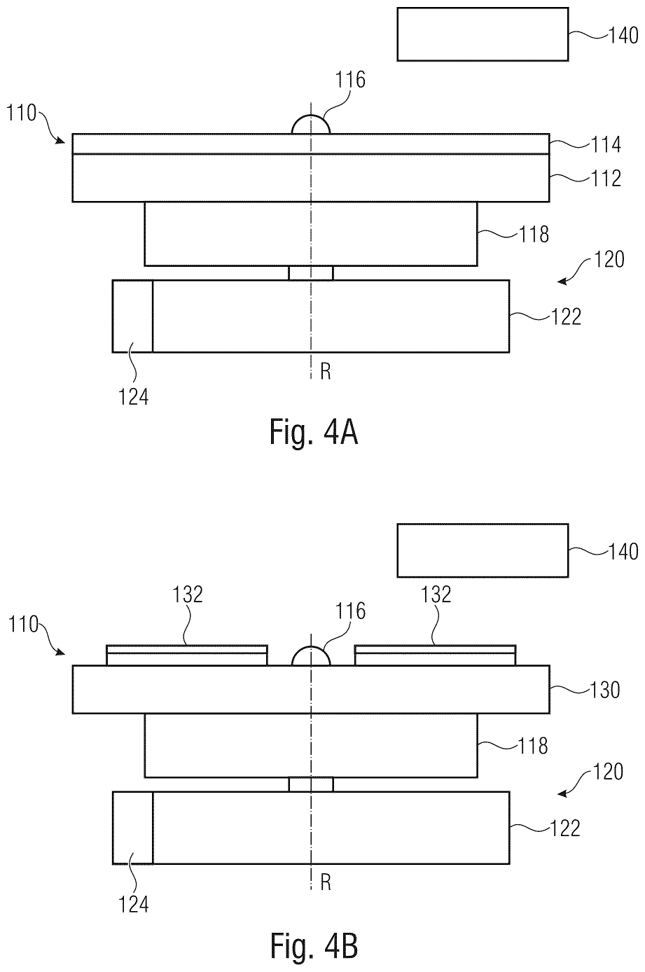

Referring to FIGS. 4a and 4b, examples of fluid handling devices in the form of centrifugal microfluidic systems according to examples of the invention are described below which use or comprise a fluidics module as described herein. In other words, the fluidics module in the systems in FIGS. 4a and 4b can be any of the fluidics modules described herein.

FIG. 4a shows a fluid handling device comprising a fluidics module in the form of a rotation body 110, which comprises a substrate 112 and a lid 114. The substrate 112 and the lid 114 can be circular in plan view, with a central opening via which the rotation body 110 can be attached to a rotating part 118 of a drive device 120 via a conventional fastening device 116. The rotating part 118 is rotatably mounted on a stationary part 122 of the drive device 120. The drive device 120 can, for example, be a conventional centrifuge, which can have an adjustable rotational speed, or also a CD or DVD drive. A control device 124 can be provided which is configured to control the drive device 120 in order to apply a rotation or rotations of different rotational frequencies to the rotation body 110. As will be apparent to those skilled in the art, the control device 124 can, for example, be implemented by a correspondingly programmed computing device or a user-specific integrated circuit. The control device 124 can additionally be configured to control the drive device 120 in response to manual inputs by a user in order to effect the rotations of the rotation body. In any case, the control device 124 can be configured to control the drive device 120 in order to apply the rotation to the rotation body in order to implement examples of the invention as described herein. A conventional centrifuge with only one rotational direction can be used as the drive device 120. The fluid handling device additionally comprises a transfer module 140 configured to introduce respective liquids into the liquid receiving regions. The control device 124 can be configured to synchronize the rotation of the fluidics module and an actuation of the transfer module 140 in order to introduce liquid into the respective inlets of the liquid receiving regions in order to implement the methods described herein. The inlets can be configured to support such an introduction and can, for example, be formed as annular structures in the fluidics module.

The rotation body 110 comprises the fluidics structures which form the fluidics modules as described herein. The fluidics structures can be formed by cavities and channels in the lid 114, the substrate 112 or in the substrate 112 and the lid 114. In examples, for example, fluidics structures can be mapped in the substrate 112, while filling openings and venting openings are formed in the lid 114. In examples, the structured substrate (including filling openings and venting openings) is arranged at the top and the lid is arranged at the bottom.

In an alternative example shown in FIG. 4b, fluidics modules 132 are inserted into a rotor 130 and form the rotation body 110 together with the rotor 130. The fluidics modules 132 may each comprise a substrate and a lid, in which in turn corresponding fluidics structures can be formed. The rotation body 110 formed by the rotor 130 and the fluidics modules 132 can in turn be applied with a rotation by the drive device 120 which is controlled by the control device 124.

In FIGS. 4a and 4b, the center of rotation about which the fluidics module or the rotation body is rotatable is denoted by R.

The described devices and methods make it possible to simultaneously meet several requirements to holding and subsequently specifically switching a liquid in the field of centrifugal microfluidics. Thus, there is the possibility of initiating the switching process by adding liquid and overcoming a siphon channel associated therewith. Furthermore, there is the possibility of sequentially repeating holding and switching. Embodiments additionally make it possible to hold and switch liquids in a robust manner which is largely independent of frequency and acceleration of the rotation, of time, liquid properties, liquid volumes of the liquid to be switched, of the temperature or thermopneumatics and the air humidity.

In embodiments, essentially only the hydrostatic heights play a role over the holding and switching of the incubation liquid, so that with very small amounts of switching liquid, since the switching structure can be implemented to be very flat and narrow, very large amounts of incubation liquid can be held, for example via a very wide and deep incubation chamber. If necessary, a medium with a significantly higher density in comparison with the incubation liquid could additionally be used as a switching liquid, with the aim of generating a higher hydrostatic counter-pressure, since the counter-pressure is essentially determined by two factors, i.e. the density and the hydrostatic heights in the siphon channel and in the connecting channel.

In summary, embodiments thus provide a method for holding and transferring liquid, in which a fluidics module is rotated about a center of rotation in order to drive parts of a first liquid from a first liquid receiving region into a siphon channel and a connecting channel without the first liquid passing into a downstream fluidics structure via an apex of the siphon channel and without the first liquid passing from the first liquid receiving region into a second liquid receiving region via the connecting channel. Parts of a second liquid are driven from a second liquid receiving region into the connecting channel in order to enclose a gas volume between the first liquid and the second liquid in the connecting channel and to hold the second liquid in the second liquid receiving region and the connecting channel. By introducing additional liquid into the first liquid receiving region, the first liquid can then be emptied into a downstream fluidics structure, thereby reducing the counter-pressure in the gas volume and transferring the second liquid into the downstream fluidics structure via the connecting channel and the siphon channel.

According to the invention, a liquid volume in an incubation chamber is thus held by a hydrostatic counter-pressure of a switching liquid located in a switching structure. Since the radial positions for the hydrostatic pressure are squared, switching structures which are radially further outward with smaller hydrostatic height differences can hold larger height differences in an incubation chamber. In this case, the air inclusion makes it possible to stabilize both fill levels and thus to compensate the pressure. Switching takes place by adding liquid in order to exceed the inverse apex of the siphon in the siphon channel and to initiate drainage of the switching liquid.

In other words, examples of the present invention provide a fluid handling device for operation in a centrifugal microfluidic device and/or a centrifuge, comprising: a vented incubation chamber configured to receive incubation liquid; a vented switching structure consisting of a switching chamber and the connected siphon channel and connecting channel configured to receive switching liquid; wherein the connecting channel is connected to the incubation chamber at a point of the incubation chamber located radially outwards; wherein the siphon channel contains an inverse siphon and is connected to any microfluidic structure located downstream; wherein the switching structure is partially filled with switching liquid; wherein the incubation structure is partially or completely filled with incubation liquid; wherein an air inclusion between incubation liquid and switching liquid is formed in the connecting channel; wherein a hydrostatic counter-pressure is formed in the switching structure, with which the incubation liquid is held in the incubation chamber, and wherein an addition of additional switching liquid results in transferring the switching liquid and the incubation liquid into any microfluidic structure located downstream.

Although features of the invention have been described on the basis of device features or method features, it will be apparent to those skilled in the art that corresponding features may also be part of a method or a device, respectively. Thus, the device can be configured to perform corresponding method steps, and the respective functionality of the device can constitute corresponding method steps.

In the above detailed description, partly different features have been grouped together in examples in order to rationalize the disclosure. This type of disclosure is not to be interpreted as intending that the claimed examples comprise more features than are expressly indicated in each claim. Rather, as the following claims reflect, the subject-matter may be in less than all the features of a single disclosed example. Consequently, the following claims are hereby incorporated into the detailed description, where each claim may stand as its own separate example. While each claim may stand as its own separate example, it is to be noted that, although dependent claims in the claims refer back to a specific combination with one or more other claims, other examples also include a combination of dependent claims with the subject-matter of each other dependent claim or a combination of each feature with other dependent or independent claims. Such combinations are included unless it is stated that a specific combination is not intended. Furthermore, it is intended that a combination of features of a claim with each other independent claim is also included, even if this claim is not directly dependent on the independent claim.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

1. A method for holding and transferring liquid using a fluidics module which comprises a first liquid receiving region, a second liquid receiving region, a downstream fluidics structure, a siphon channel with an apex and a connecting channel, wherein a portion of the first liquid receiving region which is radially outward with respect to a center of rotation is connected to the downstream fluidics structure via the siphon channel, and the radially outward portion of the first liquid receiving region is fluidically connected to an outlet of the second liquid receiving region via the connecting channel, wherein the first liquid receiving region and the second liquid receiving region are vented, wherein the connecting channel comprises a first end which is fluidically connected to the first liquid receiving region, and a second end which opens into a radially outward portion of the second liquid receiving region, wherein the first end of the connecting channel is radially further outward than the second end of the connecting channel, wherein an outlet end of the siphon channel is arranged radially further outward than a radially outward end of the first liquid receiving region and than a radially outward end of the second liquid receiving region, the method comprising:
a) rotating the fluidics module about the center of rotation in order to drive parts of a first liquid introduced into the first liquid receiving region from the first liquid receiving region into the siphon channel and the connecting channel in order to effect liquid menisci of the first liquid in the first liquid receiving region, the siphon channel and the connecting channel without the first liquid passing into the downstream fluidics structure via an apex of the siphon channel and without the first liquid passing from the first liquid receiving region into the second liquid receiving region via the connecting channel,
b) introducing a second liquid into the second liquid receiving region and rotating the fluidics module in order to drive parts of the second liquid from the second liquid receiving region into the connecting channel in order to thereby enclose a gas volume between the first liquid and the second liquid in the connecting channel and to generate a counter-pressure in the gas volume by which the second liquid is held in the second liquid receiving region and the connecting channel, and
c) introducing additional liquid into the first liquid receiving region in order to move the liquid meniscus of the first liquid over the apex of the siphon channel in order to thereby empty the first liquid from the first liquid receiving region into the downstream fluidics structure via the siphon channel, thereby reducing the counter-pressure in the gas volume and transferring the second liquid from the second liquid receiving region into the downstream fluidics structure via the connecting channel and the siphon channel.

2. The method according to claim 1, wherein introducing the first liquid into the first liquid receiving region, introducing the additional liquid into the first liquid receiving region and/or introducing the second liquid into the second liquid receiving region take place manually or using a transfer module.

3. The method according to claim 1, wherein the fluidics module comprises a further liquid receiving region, a further downstream fluidics structure, a further siphon channel and a further connecting channel, wherein a portion of the further liquid receiving region which is radially outward with respect to the center of rotation is connected to the further downstream fluidics structure via the further siphon channel, and the radially outward portion of the further liquid receiving region is fluidically connected to the first outlet or a further outlet of the second liquid receiving region via the further connecting channel, the method comprising:
after or during a), rotating the fluidics module about the center of rotation in order to drive parts of a third liquid introduced into the further liquid receiving region from the further liquid receiving region into the further siphon channel and the further connecting channel in order to effect liquid menisci of the third liquid in the further liquid receiving region, the further siphon channel and the further connecting channel without the third liquid passing into the further downstream fluidics structure via an apex of the further siphon channel and without the third liquid passing from the further liquid receiving region into the second liquid receiving region via the further connecting channel,
after c), introducing a fourth liquid into the first liquid receiving region and rotating the fluidics module in order to drive parts of the fourth liquid from the first liquid receiving region into the siphon channel and the connecting channel in order to effect liquid menisci of the fourth liquid in the first liquid receiving region, the siphon channel and the connecting channel without the fourth liquid passing into the downstream fluidics structure via an apex of the siphon channel and without the fourth liquid passing from the first liquid receiving region into the second liquid receiving region via the connecting channel,
introducing a fifth liquid into the second liquid receiving region and rotating the fluidics module in order to drive parts of the fifth liquid from the second liquid receiving region into the connecting channel and the further connecting channel in order to thereby enclose a gas volume between the third liquid and the fifth liquid in the further connecting channel and between the fourth liquid and the fifth liquid in the connecting channel and to generate a further counter-pressure by which the fifth liquid is held in the second liquid receiving region and the further connecting channel, and
introducing additional liquid into the further liquid receiving region in order to move the liquid meniscus of the third liquid over the apex of the further siphon channel in order to thereby empty the third liquid from the further liquid receiving region into the further downstream fluidics structure via the further siphon channel, thereby reducing the further counter-pressure and transferring the fifth liquid from the second liquid receiving region into the further downstream fluidics structure via the further connecting channel and the further siphon channel.

4. The method according to claim 1, wherein transferring the second liquid into the downstream fluidics structure causes the second liquid to be brought into contact with a reagent.

5. A fluidics module for performing a method according to claim 1, which comprises the vented first liquid receiving region, the vented second liquid receiving region, the siphon channel and the connecting channel.

6. A fluidics module for performing a method according to claim 3, which comprises the vented first liquid receiving region, the vented second liquid receiving region, the siphon channel, the connecting channel, the further liquid receiving region, the further downstream fluidics structure, the further siphon channel and the further connecting channel, wherein
the further liquid receiving region is vented,
the further connecting channel comprises a first end which is fluidically connected to the further liquid receiving region, and a second end which opens into a radially outward portion of the second liquid receiving region, wherein the first end of the further connecting channel is radially further outward than the second end of the further connecting channel,
an outlet end of the further siphon channel is arranged radially further outward than a radially outward end of the further liquid receiving region and than a radially outward end of the second liquid receiving region.

7. The fluidics module according to claim 6, wherein, in the azimuthal direction, the first liquid receiving region is arranged on one side of the second liquid receiving region and the further liquid receiving region is arranged on an opposite side of the second liquid receiving region.

8. The fluidics module according to claim 5, wherein the connecting channel comprises a channel portion which extends radially inwardly and is arranged in the azimuthal direction on one side of the first liquid receiving region, and the siphon channel comprises a channel portion which extends radially inwardly and is arranged in the azimuthal direction on an opposite side of the first liquid receiving region.

9. The fluidics module according to claim 6, wherein the connecting channel comprises a channel portion which extends radially inwardly and is arranged in the azimuthal direction on one side of the first liquid receiving region, and the siphon channel comprises a channel portion which extends radially inwardly and is arranged in the azimuthal direction on an opposite side of the first liquid receiving region.

10. The fluidics module according to claim 5, wherein the first liquid receiving region is a fluid chamber, wherein the connecting channel and the siphon channel open into the fluid chamber on opposite azimuthal sides.

11. The fluidics module according to claim 6, wherein the first liquid receiving region is a fluid chamber, wherein the connecting channel and the siphon channel open into the fluid chamber on opposite azimuthal sides.

12. A fluid handling device comprising:
a fluidics module for performing a method according to claim 1, which comprises the vented first liquid receiving region, the vented second liquid receiving region, the siphon channel and the connecting channel; and
a drive device configured to rotate the fluidics module for performing a method according to claim 1.

13. The fluid handling device according to claim 12, which additionally comprises at least one transfer module configured to introduce the first liquid into the first liquid receiving region, to introduce the additional liquid into the first liquid receiving region and/or to introduce the second liquid into the second liquid receiving region.
